(19) United States
(12) Patent Application Publication
(10) Pub. No.: US 2012/0173051 A1
(43) Pub. Date: Jul. 5, 2012

(54) OEM safe aftermarket gateway

(76) Inventor: Stephan A. Tarnutzer, Shelby Township, MI (US)

(21) Appl. No.: 13/374,555

(22) Filed: Jan. 3, 2012

Related U.S. Application Data
(60) Provisional application No. 61/460,593, filed on Jan. 5, 2011.

(51) Int. Cl. G06F 17/00

(52) U.S. Cl. 701/2; 701/1

(57) ABSTRACT

The OEM safe aftermarket gateway is used to enable aftermarket devices and systems that the OEM did not design or specify to be connected to the OEM vehicles without negatively affecting the electronics system of the vehicle. The OEM safe aftermarket gateway protects the OEM vehicle communication bus from aftermarket devices and systems, yet still enables aftermarket devices and systems to function as intended. The OEM safe aftermarket gateway enables the ‘bridging’ between the OEM vehicle communication bus and the aftermarket suppliers requiring access to the communication bus. The OEM safe aftermarket gateway is similar to what a firewall and router do for the Internet industry. The OEM safe aftermarket gateway protects the proprietary information of each party and yet still enables an aftermarket supplier to access the OEM vehicle communication bus through a safe and reliable system.

This application is related to and claims priority to U.S. Provisional Application No. 61/460,593, entitled “OEM Safe Aftermarket Gateway for Vehicle Data Et Controls”, filed on Jan. 5, 2011.

### FIELD OF THE INVENTION

The invention relates to a vehicle gateway device, module, or software component for installation in an automotive vehicle, and more particularly, to the exchange of data over such a gateway for use by OEMs and aftermarket applications to gather information or control vehicle functions, and, in particular, this vehicle gateway device uses OEM specific and defined interfaces to establish the wired direct connection to the OEM vehicle communication bus.

### BACKGROUND OF THE INVENTION

In the automotive industry, computer communications are often specialized, proprietary communication buses that are optimized for embedded environments. Aftermarket suppliers need access to these communication buses to provide solutions that are competitive with those manufactured by OEMs. In addition, in a time of global recession, OEMs need to keep the cost of the vehicles they sell down so that the vehicles in their fleet are affordable. As a result, OEMs and aftermarket suppliers have a real opportunity to offer a broader range of options to the OEM customer base to make the vehicles more marketable.

Aftermarket suppliers are handicapped in providing systems that are competitive with those manufactured by OEMs, since the aftermarket suppliers have had limited, at best, access to the OEM vehicle communication bus. As more of the vehicles become computerized, and many of these computer systems are synchronized, aftermarket suppliers must have limited and safe access to the OEM vehicle communication bus, in order to provide quality parts and systems while keeping the price of the vehicles competitive while operating safely. There is an opportunity for OEMs and aftermarket supplies to partner and add content that is both safe and reliable.

Some of the gateways provided by others include the following:
U.S. Patent Document No. 20100198427 (Fogelstrum et al.) discloses an open architecture for a dynamic vehicle network. The self-configuring and self-learning network optimizes itself for battery usage, and allows users to mount modules implementing new functionality to the vehicle at any location on the vehicle. The use of network zones and wireless gateways between zones reduces network traffic within zones by isolating data not required outside a zone from the other zones.
U.S. Patent Document No. 20100131816 (Yamamoto et al.) discloses a communication system and method for a car that performs data transmission under extensive range from a low speed communication to high speed communication, without generating data delay, and data dropout caused by the data sending collision. A communication system adapting for the car that mounts several buses on the car each of which is connected to a few electronic control units. In this configuration, several buses are connected through a gateway. This configuration reduces generation frequency of data sending collision at each bus and reduces occurrence of data delay, and data dropout, because a few electronic control units performs data transmission within each bus and data transmission between electronic control units connected to different buses is performed through the gateway.
U.S. Patent Document No. 20080304502 (Matsuo) discloses a vehicle gateway device, a communication data control method and a computer program product for use therewith. The vehicle gateway device involves a relay function unit for relaying communication data if communication data flowing on a bus line is relay data, and a network management function unit for performing a network management process in accordance with network management data if communication data flowing on the bus line is network management data transmitted for the implementation of a network management function. The relay function unit is constructed by an application specific integrated circuit, and the network management function unit is constructed by a microcomputer. As a result, the vehicle gateway device can perform processes of the relay function unit and can add a new function to the network management function unit without employing a high-performance microcomputer.

U.S. Pat. No. 7,523,237 (Gerig) discloses a method and a protocol for diagnostics of arbitrarily complex networks of devices. A computer data signal is provided, the computer data signal being embodied in an electrical signal represented as a plurality of bits for communicating a message over a network including multiple computer devices coupled to at least one communication bus utilizing a communication bus protocol. The computer data signal includes a transport portion supporting transport layer functions compatible with the communication bus protocol of the at least one communication bus over which the message is transmitted; and a common transport portion operably connected to the transport portion and supporting transport layer functions. The common transport portion enables the message to be abstracted from the communication bus protocol.
U.S. Pat. No. 6,700,795 (Jones, et al.) discloses a scalable, modular architecture for automotive power distribution and body control functions. The system comprises semi-custom two-tier nodes which are distributed in locations around the vehicle to service load devices associated with or found in different regions of the automobile topology. A multiplexed control network interconnects the nodes along with a two-wire bus. Each node consists of a first common board carrying a microcontroller and a basic number of FET driver switches associated with a basic level of accessorization for that region of the vehicle. Each node further comprises a second larger pass through board which supports the first common board in spaced parallel relationship therewith and which carries terminal connectors. The larger pass through board has vacant locations for the addition of FET drivers needed for higher levels of accessorization. These locations are pre-connected to the microcontroller but are unused in vehicles with lower levels of accessorization.

What is needed is a vehicle control system capable of serving as a vehicle network gateway for the plurality of connected remote sources and a vehicle communication buses. What is needed is a vehicle network gateway capable of facilitating multiple simultaneous data connections with a plurality of remote sources. What is needed is a vehicle control system capable of facilitating the transfer of data from vehicle hardware modules to remote sources and for remote sources to be able to control existing OEM features. What is needed is an OEM safe aftermarket gateway that completely isolates the aftermarket device from the OEM system and the network to maintain the network integrity and the vehicle safety and warranty.

What is needed is an OEM safe aftermarket gateway to provide gateways and vehicle bus interfaces that can provide aftermarket devices with access to vital vehicle information such as, but not limited to, vehicle speed, RPM, temperature, door lock information, airbag deployment severity, pressure data, and fuel usage. What is needed is an OEM safe aftermarket gateway to provide the aftermarket devices and systems with a means to safely and with the consent of the OEM to control certain OEM features and functions such as, but not limited to, opening power sliding doors, unlock or lock doors, and remote start.

What is needed is an OEM safe aftermarket gateway by creating connectivity to the vehicle that protects and addresses the proprietary data concerns of the OEM. What is needed is an OEM safe aftermarket gateway that provides the aftermarket with vehicle connectivity that is OEM approved.

### SUMMARY OF THE INVENTION

The OEM safe aftermarket gateway of the present invention addresses the above needs.

The OEM safe aftermarket gateway enables aftermarket devices and systems that the OEM did not design or specify to be connected to the OEM vehicle without negatively affecting the electronics system of the vehicle. The OEM safe aftermarket gateway of the present invention protects the OEM vehicle communication bus from aftermarket devices and systems yet still enables aftermarket devices and systems to function as intended. The OEM safe aftermarket gateway enables the ‘bridging’ between the OEM vehicle communication bus and the aftermarket suppliers requiring access to the OEM vehicle communication bus. The OEM safe aftermarket gateway of the present invention does what a firewall and router do for the Internet industry. A firewall is software or hardware that helps guard your computer against hackers as well as some computer viruses and worms that try to reach your computer when its connected to the Internet. In many ways, a firewall is like a gateway; it enables connections from sources it trusts, and it blocks out the connections that it does not trust. There are two basic types of firewalls: (a) software firewalls; and (b) hardware routers with firewalls. The OEM safe aftermarket gateway protects each party's proprietary information and yet still enables access to the OEM vehicle communication bus to aftermarket suppliers through a safe and reliable system. One way this is accomplished is by talking the communication language or protocol on the OEM vehicle bus side and a different language or protocol, or the same but with different messages (i.e. ‘re-packaging’ of the OEM messages or data), on the aftermarket device side.

Working with OEMs and aftermarket suppliers interested in connecting devices to the vehicle to gain access to various vehicle data, it has become evident that instead of reverse engineering the protocols, type of network management, transportation layer, diagnostics, and physical layer interface used for each type of vehicle that the data was needed from, a more collaborative and effective approach or method is needed. The OEM safe aftermarket gateway of the present invention enables all stakeholders to benefit without having to worry about the respective proprietary information of each party. That is when the OEM safe aftermarket gateway is fully operational to create a gateway that bridges the OEM and aftermarket world in a safe, reliable, and beneficial manner for all stakeholders.

The OEM safe aftermarket gateway as used in the present invention is a vehicle communication bus access gateway module that gates messages between the communication buses of the vehicle and the aftermarket devices and systems. This is accomplished with the OEM safe aftermarket gateway of the present invention. The OEM safe aftermarket gateway is can be validated for proper functionality by the OEM and can therefore be the only module tested by the OEM enabling an unlimited number of aftermarket devices or systems to be safely connected to the OEM vehicle without the need to test every individual device or system independently that desires to be used for a particular vehicle. In essence, the OEM safe aftermarket gateway of the present invention creates a standard aftermarket interface module that all aftermarket devices can use and the OEM can trust. This also enables the OEMs to deploy this gateway as the only device to suffice a customer need, making it essentially “the” OEM solution.

This OEM safe aftermarket gateway can be in the form of a standalone electronic module or device, integrated into another aftermarket device, or a software component that is integrated into an existing OEM module. All of these possible forms use automotive OEM specific and approved software components that have been tested and validated by the OEMs to assure vehicle operational conformance. This invention uses the OEM specific and proper physical layer communication bus interface, the appropriate transport layer and network management implementation to match the OEMs implemented transport layer and network management, along with the correct and OEM approved communication bus driver stack software and bus protocols with the respective message IDs and signals to control vehicle features.

The OEM safe aftermarket gateway of the present invention is used by an aftermarket device or system (non-OEM device or system in the form of physical hardware or a software application residing in an existing module) to get vehicle data required for its operation or to control certain OEM vehicle features and functions in addition to the normal usage or application of these functions if there is no OEM safe aftermarket gateway connected. Such device or system connects to the OEM safe aftermarket gateway, via a wired or wireless connection or an application processor interface in the case of a sandbox application, the application processor interface is provided by the OEM safe aftermarket gateway of the present invention, which then receives or requests vehicle data that the. OEM vehicle bus connection provides.

For a more complete understanding of the OEM safe aftermarket gateway of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 discloses a general schematic of an OEM safe aftermarket gateway of the present invention, which enables access to vital OEM vehicle communication bus information while protecting the proprietary information of the OEM. It is a high-level, graphical representation.

FIG. 2 discloses a simplified schematic process or flow-method of the OEM safe aftermarket gateway of FIG. 1, whereby an OEM sign-off and OEM vehicle warranty apply to a system or device supplied by an aftermarket supplier.

FIG. 3 discloses a simplified block-diagram of OEM safe aftermarket gateway of the present invention that is integrated into an existing OEM module, depicting the vehicle communication bus, the OEM control module, the OEM control module vehicle communication bus software, and the OEM safe aftermarket gateway of FIG. 1. The OEM safe aftermarket gateway can have either a wired or wireless connection to a sandbox with a software based OEM safe aftermarket gateway component that is standalone or part of the sandbox, an aftermarket application having either a wired or wireless connection to an aftermarket device or system.

FIG. 4 discloses a simplified block-diagram depicting the parallel linkage of a specific control function disposed within the OEM vehicle via the vehicle communication bus, and the OEM control module that are factory installed, or the OEM safe aftermarket gateway of FIG. 1 via the aftermarket device, product, or system.

FIG. 5 discloses a simplified block-diagram of the OEM communication bus architecture for implementation with the OEM safe aftermarket gateway for vehicle of FIG. 1. It shows how certain OEM data and/or features through the means of specific OEM defined commands, diagnostics commands, or via spoofing can be accomplished by the OEM safe aftermarket gateway module.

FIG. 6 discloses a simplified logic diagram depicting how spoofing is used in the OEM safe aftermarket gateway of FIG. 1.

### DETAILED DESCRIPTION OF THE PREFERRED EMBODIMENTS

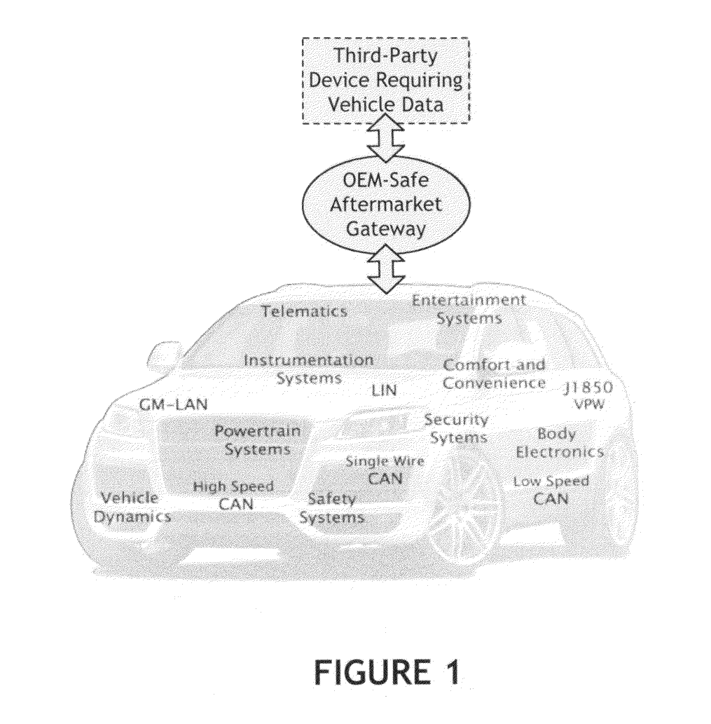

Referring now to the drawings, FIG. 1 depicts of a general schematic of an OEM safe aftermarket gateway of the present invention, which enables access to vital OEM vehicle communication bus information while protecting the proprietary information of the OEM.

A first preferred embodiment of the OEM safe aftermarket gateway of the present invention is in the form of an electronic control module that includes a printed circuit board, one or more microprocessors, and various other electronic components such as wireless chips, and associated control and communication software.

A second preferred embodiment of the OEM safe aftermarket gateway of the present invention is in the form of a software module only as part of the software of an existing or new OEM control module that besides its base functionality also performs the function of an OEM safe aftermarket gateway. The software-only OEM safe aftermarket gateway of the present invention may be accessible through the published Application Processor Interface through a sandbox type application on the OEM safe aftermarket gateway software containing device.

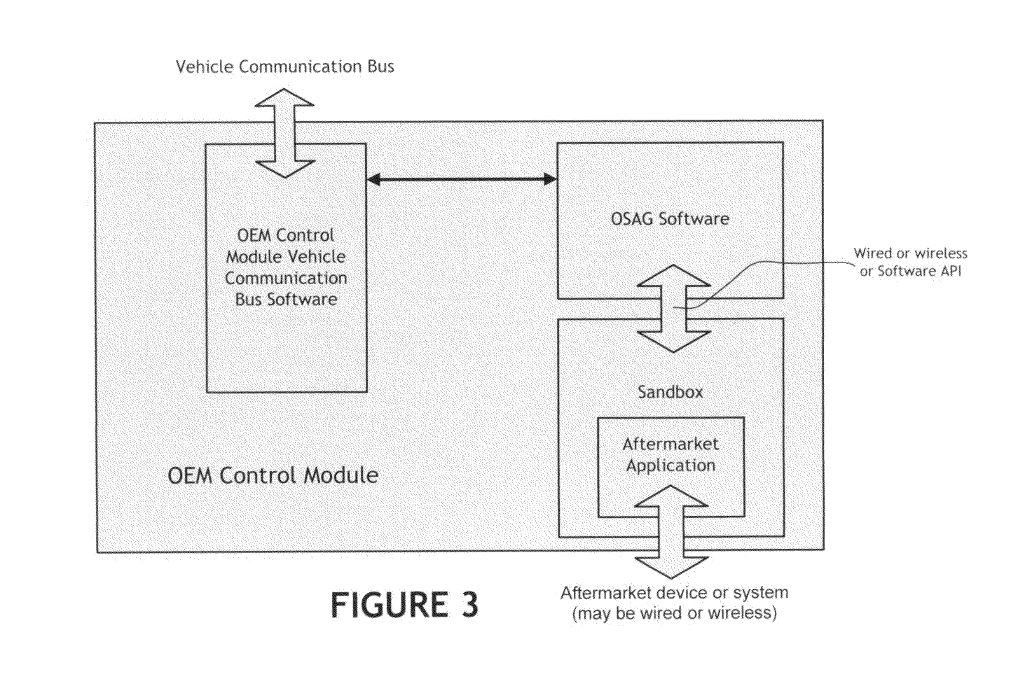

FIG. 3 discloses a simplified block-diagram of OEM safe aftermarket gateway of the present invention that is integrated into an existing OEM module, depicting the vehicle communication bus, the OEM control module, the OEM control module vehicle communication bus software, and the OEM safe aftermarket gateway of FIG. 1. The OEM safe aftermarket gateway can have either a wired or wireless connection to a sandbox with a software based OEM safe aftermarket gateway component that is standalone or part of the sandbox, an aftermarket application having either a wired or wireless connection to an aftermarket device or system.

The sandbox is a partitioned-off and secured, non-volatile memory space in the microprocessor of an existing OEM module that is acting as or used for the OEM safe aftermarket gateway functionality. The sandbox memory space provides a flashable space where the aftermarket device supplier can load application software into that is needed for that device to get the vehicle data information needed and the ability to control OEM features. The sandbox design provides a safe space for aftermarket software to reside inside an OEM module without the ability for the aftermarket software to be able to negatively affect the operation of the existing OEM module as well as the vehicle's operation in general. The sandbox acts as and performs the functionality of a traditional firewall, filter, or gateway protecting the operation of the car while providing access via defined software application processor interfaces for the aftermarket software to interact with the vehicle. The application processor interface allows a controlled method for the aftermarket device to control certain (pre-defined) features of the vehicle through the aftermarket software application residing in the sandbox. The actual aftermarket device (physical hardware located outside of the OEM module) interacts with the aftermarket software residing in the sandbox via another application processor interface (defined communication interface) that allows for only a predefined set of functions to occur. In this configuration of the OEM safe aftermarket gateway of the present invention, the sandbox can be flashed via a variety of different methods (wired or wireless) depending on the type of OEM module that the sandbox resides in.

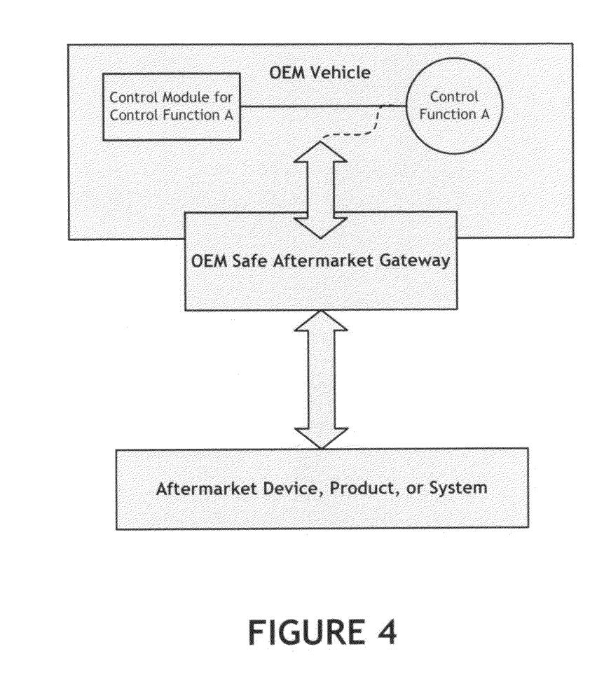

FIG. 4 discloses a simplified block-diagram of the OEM safe aftermarket gateway's control of certain OEM features via the means of specific OEM defined commands for the gateway module or via ‘spoofing’ other, currently existing, OEM modules that are factory-installed and connected to the vehicle communication bus. The OEM safe aftermarket gateway module uses OEM standard approved software modules to connect the vehicle bus as well as approved hardware designs. The OEM safe aftermarket gateway module masquerades as the OEM control module and spoofs the control function. The wired or wireless link between the OEM safe aftermarket gateway module and the aftermarket device, product, or system is preferably Ethernet, LIN, RS232, BT, WiFi, GSM/CDMA, or the like, using an application processor interface (defined communication interface).

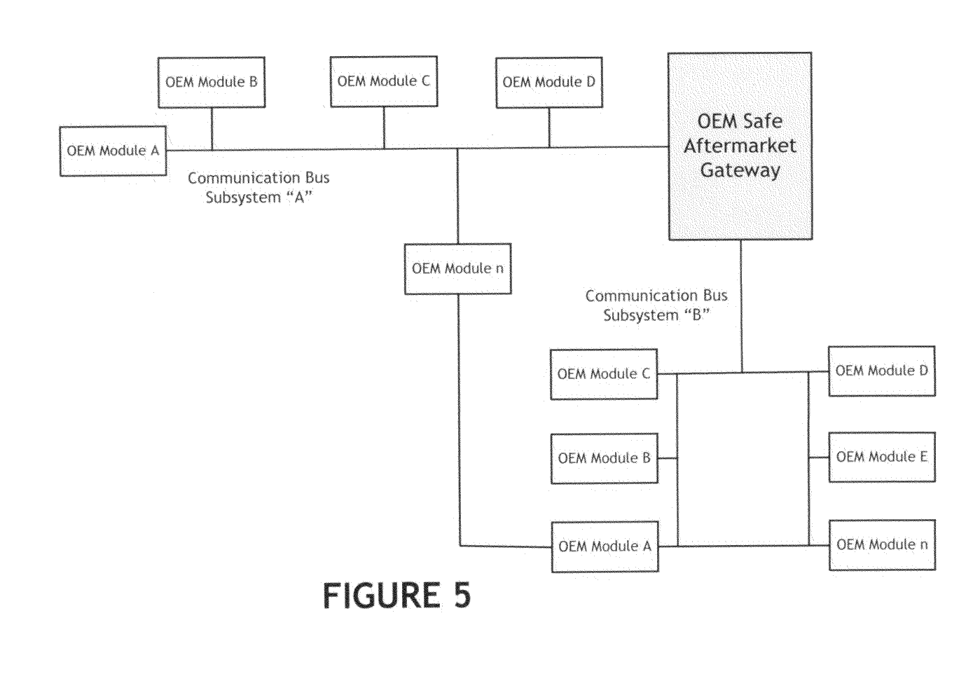

FIG. 5 discloses a simplified block-diagram of an OEM communication bus architecture with the various technical features that require this invention to apply its in-depth technical understanding and unique processes to implement the OEM safe aftermarket gateway's control of certain OEM features via the means of specific OEM defined commands for the gateway module, diagnostics commands, or via spoofing. Each of the OEM modules of the communication bus subsystem A are digitally linked to the OEM safe aftermarket gateway, as are each of the OEM modules of the communication bus subsystem B. In addition, communication bus subsystem A is digitally linked to communication bus subsystem B through OEM module n of communication bus subsystem A. The OEM safe aftermarket gateway includes a main processor and in certain application may also include a safety back-up microprocessor. The microprocessor(s) includes diagnostics and watchdogs, including message collision detection and avoidance software applications. The linkages between each of the OEM modules and the OEM safe aftermarket gateway have hardware interfaces (transceiver and circuitry) designs, which meet OEM specifications for their respective communication bus subsystems. In addition, the linkages between each of the OEM modules and the OEM safe aftermarket gateway use OEM physical layer interface and bus driver stack software for their respective communication bus subsystems.

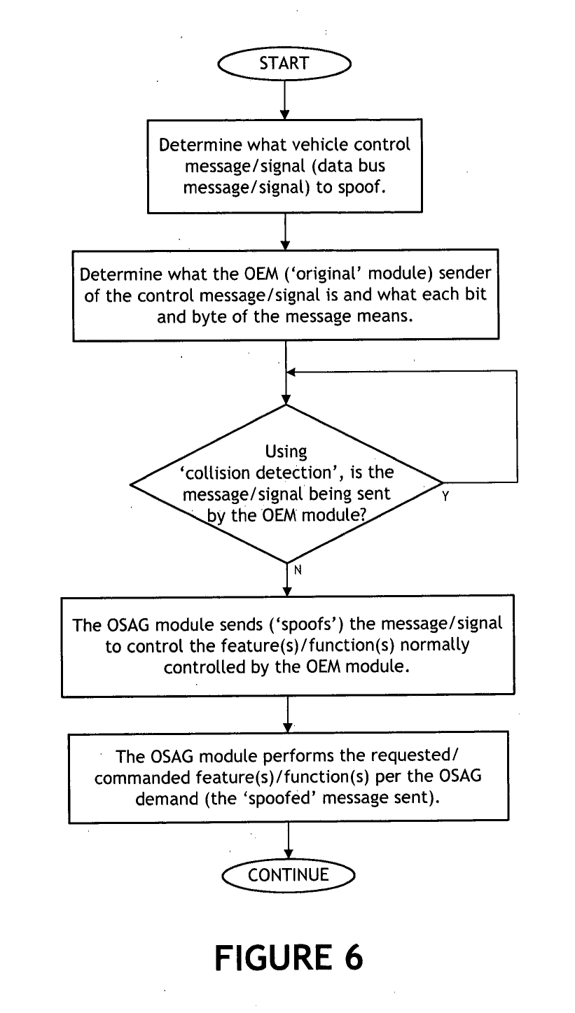

FIG. 6 discloses a simplified logic diagram depicting how spoofing is used in the OEM safe aftermarket gateway of the present invention. If the OEM control module is sending the message or signal to be spoofed by the OEM safe aftermarket gateway module, then the OEM safe aftermarket gateway module cannot send that same message or signal as otherwise the messages or signals from both modules may collide (sending opposite commands for the same function at the same time) and have negative effects on the OEM vehicle system. Collision detection software in the OEM safe aftermarket gateway module determines if the OEM control module is currently sending the message or signal, and if so, waits until the OEM control module is finished. The OEM safe aftermarket gateway module spoofs the message or signal to control the features or functions normally controlled by the OEM control module using the exact same commands as the OEM control module, thereby masquerading as the OEM control module from the perspective of the module receiving the control command message. The receiving module is spoofed.

The OEM safe aftermarket gateway of the present invention communicates on one side with the OEM vehicle communication buses directly and not through OBD or OBDII. On the other side, the OEM safe aftermarket gateway of the present invention communicates with the aftermarket device on a different type of the communication bus (either wired or wireless) using a standard application processor interface so that the aftermarket device is unable to interfere with the OEM communication buses.

The key component parts of the OEM safe aftermarket gateway of the present invention are:
The OEM approved vehicle data communication bus software (drivers, application software, transport layer, network management, diagnostics, bus protocol, etc.) and physical layer interface electronic bus transceiver part components.
The OEM safe aftermarket gateway with printed circuit board and micro processors along with other electronic parts assembled into control circuits. This may include wired or wireless connections, such as but not limited to, WiFi, Bluetooth, Infrared, GPRS/GSM, and CDMA.
The OEM safe aftermarket gateway software module residing in the software structure of an existing OEM control module (perhaps, a sandbox) providing the OEM safe aftermarket gateway of the present invention functionality via existing connections (either wired or wireless) available by the existing OEM module.
The OEM safe aftermarket gateway application processor interface documenting and describing the available (public information) commands for requesting and sending vehicle data on the OEM vehicle communication bus.

The OEM safe aftermarket gateway of the present invention is used for OEMs to enable aftermarket devices and systems that the OEM did not design or specify to be connected to the OEM vehicles without negatively affecting the vehicle's electronics system. The OEM safe aftermarket gateway of the present invention protects the OEM vehicle system from aftermarket devices and systems yet still allows the aftermarket products and systems to function as intended. Therefore, the OEM safe aftermarket gateway of the present invention “bridges” between the OEM vehicle communication bus and the “outside world” interested in the data and in controlling certain features of the car that would otherwise not be possible or interfere with the controls methods and strategies of the OEM control module(s). The control of certain features can be done by the OEM safe aftermarket gateway via the means of specific OEM defined commands for the gateway module, use of OEM diagnostics commands (OEM diagnostics commands in many cases allows for certain ON/OFF features to be controlled), or via spoofing other, currently existing, OEM modules that are factory-installed and connected to the vehicle communication bus. In other words, the OEM safe aftermarket gateway masquerades as a particular OEM module to perform a specific control function. This means that the OEM safe aftermarket gateway communicates the proper commands on the vehicle communication bus that during ‘normal or standard’ operation are sent by different modules.

Rather than using reverse engineering to access the vehicle communication bus data, the vehicle communication bus protocol is provided by the OEM. The invention disconnects the OEM vehicle bus from the aftermarket device or product by the means of a different protocol and physical layer interface (i.e. different type of communication than what the OEM vehicle bus is using making them incompatible and therefore protecting the vehicle bus from any malfunctioning aftermarket device).

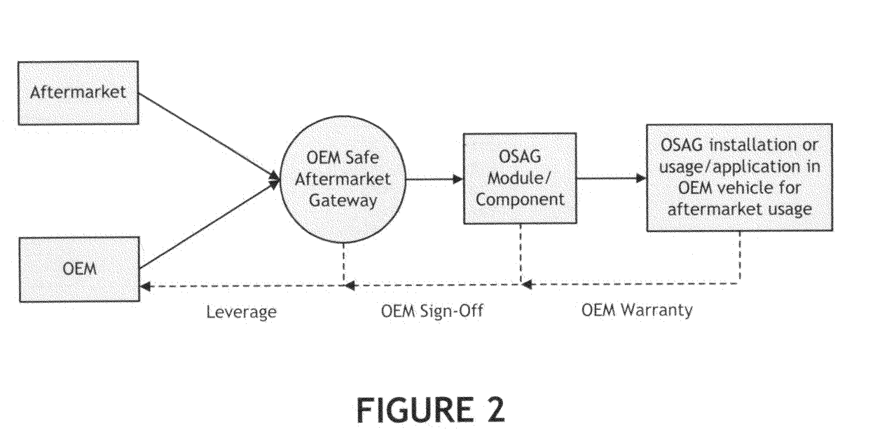

The OEM continues to provide the factory warranty to the aftermarket modified or enhanced vehicle despite modifications or devices added to the modified OEM vehicle as shown in FIG. 2.

The OEM safe aftermarket gateway bridges the gap between the OEM and the aftermarket suppliers. OEMs need to validate and test only one single device, the OEM safe aftermarket gateway, to provide access to their vehicle data for a multitude of aftermarket products and systems instead of every aftermarket product and system individually, which results in huge cost savings. The OEM safe aftermarket gateway of the present invention protects and safeguards the proprietary information of the OEM vehicle communication bus and protects the integrity of the electrical system of the vehicle.

The OEM safe aftermarket gateway of the present invention enables aftermarket devices and systems that the OEM did not design or specify to be connected to the OEM vehicles without negatively affecting the electronics system of the vehicle. The OEM safe aftermarket gateway protects the OEM vehicle communication bus from aftermarket devices and systems, yet still enables aftermarket devices and systems to function as intended. The OEM safe aftermarket gateway enables the ‘bridging’ between the OEM vehicle communication bus and the aftermarket suppliers requiring access to the communication bus. The OEM safe aftermarket gateway is similar to what a firewall and router do for the Internet industry. The OEM safe aftermarket gateway protects the proprietary information of each party and yet still enables an aftermarket supplier to access the OEM vehicle communication bus through a safe and reliable system.

Some of these critical components or features that this system provides are:
Proper OEM implementation and design of transport layer, network management, power management, support of diagnostics for both aftermarket and OEM usage;
Internal gateway module safety features, such as watchdogs or back-up or safety processors;
OEM specific physical layer hardware interface design; and
OEM and target vehicle specific communication bus software driver stack and bus protocols with the message IDs and signals that are of interest and approved for use by the OEMs.

The unique architecture assures the OEM safe aftermarket gateway is properly and physically connected to the various communication buses of interest as with modern automotive communication bus systems numerous rules and specifications for merely connecting to the bus need to be followed. In many cases, the OEM safe aftermarket gateway connects to more than just one of the OEM communication bus networks on a car and as a result may use different strategies or implementations of the mentioned above for each unique sub-system bus (transport layer, network management, physical layer, communication protocol, diagnostics, etc.). When spoofing is used, the OEM safe aftermarket gateway and the process used assesses possible collision of communication bus commands where the OEM module may command an ‘OFF’ and the aftermarket gateway an ‘ON’ of a function. In cases of possible collisions for certain applications, the OEM safe aftermarket gateway implements conflicting message collision detection software features to prevent this situation from occurring.

The interface is achieved with the OEM safe aftermarket gateway and configuration of the present invention that can be used by the aftermarket community to be connected to the OEM communication bus directly and not only through the J1962 Diagnostics port that is part of the OBDII requirement as such connectivity is limited in its data wealth and essentially provides little control functionality capabilities. A direct OEM communication bus connection enables data gathering and controls of features that otherwise are not possible.

Throughout this specification, various Patent and Applications are referenced by application number and inventor. The disclosures of these Patents and Applications are hereby incorporated by reference in their entireties into this specification in order to more fully describe the state-of-the-art.

It is evident that many alternatives, modifications, and variations of the present invention and any others disclosed herein of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

1. An OEM safe aftermarket gateway, said gateway enabling access to OEM vehicle communication bus software that includes proprietary data; and an aftermarket application in communication with an aftermarket device or system, said OEM safe aftermarket gateway providing said aftermarket with vehicle connectivity that is OEM approved, one digital connection of said OEM safe aftermarket gateway is via said OEM control module vehicle communication bus software, and another digital connection of said OEM safe aftermarket gateway communicates is via said aftermarket device or system, said aftermarket device or system being unable to communicate directly or interfere with said OEM control module vehicle communication bus software.

2. The OEM safe aftermarket gateway of claim 1, wherein said OEM safe aftermarket gateway creates connectivity to said OEM vehicle that protects and addresses the proprietary data concerns of said OEM.

3. The OEM safe aftermarket gateway of claim 1, wherein said OEM safe aftermarket gateway provides said aftermarket supplier with vehicle connectivity that is OEM approved.

4. An OEM control module for use with an OEM vehicle, said OEM control module comprising:
a) OEM control module vehicle communication bus software which includes OEM proprietary data; and
b) an OEM safe aftermarket gateway linked to said OEM control module vehicle communication bus software; and
c) an aftermarket application in communication with an aftermarket device or system, said OEM safe aftermarket gateway providing said aftermarket with vehicle connectivity that is OEM approved; and
whereby one digital connection of said OEM safe aftermarket gateway is via said OEM control module vehicle communication bus software, and another digital connection of said OEM safe aftermarket gateway communicates is via said aftermarket device or system so that said aftermarket device or system is unable to communicate directly or interfere with said OEM control module vehicle communication bus software.

5. The OEM control module of claim 4, wherein said OEM safe aftermarket gateway creates connectivity to said OEM vehicle that protects and addresses the proprietary data concerns of said OEM.

6. The OEM control module of claim 4, wherein said OEM safe aftermarket gateway provides said aftermarket supplier with vehicle connectivity that is OEM approved.

7. An OEM control module for use with an OEM vehicle, said OEM control module comprising:
a) OEM control module vehicle communication bus software which includes OEM proprietary data; and
b) an OEM safe aftermarket gateway linked to said OEM control module vehicle communication bus software via a sandbox; and
c) an aftermarket application in communication with an aftermarket device or system, said OEM safe aftermarket gateway isolating said aftermarket device or system from said OEM control module vehicle communication bus software to maintain network integrity, said OEM safe aftermarket gateway providing said aftermarket with vehicle connectivity that is OEM approved;
whereby said sandbox acts as a gateway protecting the operation of the OEM vehicle while providing access via defined software Application Processor Interfaces for aftermarket software to interact with said OEM vehicle bus communication software; and
whereby said aftermarket device or system uses said OEM safe aftermarket gateway to process vehicle data required for the operation of said aftermarket device or system or to control specific OEM vehicle features and functions, said aftermarket device or system being interfaced with said OEM safe aftermarket gateway receiving or requesting vehicle data that said OEM vehicle bus communication software provides.

8. The OEM control module of claim 7, wherein the sandbox is a partitioned-off and secured, non-volatile memory space of said OEM control module.

9. The OEM control module of claim 7, wherein said OEM safe aftermarket gateway creates connectivity to said OEM vehicle that protects and addresses the proprietary data concerns of said OEM.

10. The OEM control module of claim 7, wherein said OEM safe aftermarket gateway provides said aftermarket supplier with vehicle connectivity that is OEM approved.

11. The OEM control module of claim 7, wherein the sandbox provides a safe space for aftermarket software to reside inside said OEM control module without the ability for said aftermarket software to be able to negatively affect the operation of said OEM control module.

12. An OEM control module for use with an OEM vehicle, said OEM control module comprising:
a) OEM control module vehicle communication bus software which includes OEM proprietary data; and
b) an OEM safe aftermarket gateway linked to said OEM control module vehicle communication bus software; and
c) an aftermarket application in communication with an aftermarket device or system, said OEM safe aftermarket gateway providing said aftermarket with vehicle connectivity that is OEM approved; and
whereby said OEM safe aftermarket gateway masquerades as said OEM control module to perform specific control functions via communication of proper commands routinely sent by said OEM control module, said OEM safe aftermarket gateway spoofing to control the feature or function normally controlled by said OEM control module; and
whereby one digital connection of said OEM safe aftermarket gateway is via said OEM control module vehicle communication bus software, and another digital connection of said OEM safe aftermarket gateway communicates is via said aftermarket device or system so that said aftermarket device or system is unable to communicate directly or interfere with said OEM control module vehicle communication bus software.

13. The OEM control module of claim 12, wherein collision detection is used to determine if the same or similar message or signal is being sent by the OEM control module.

14. The OEM control module of claim 12, wherein said OEM safe aftermarket gateway isolates said aftermarket device or system from the OEM system and the network to maintain the network integrity and the vehicle safety.

15. The OEM control module of claim 12, wherein a vehicle control system capable of facilitating the transfer of data from vehicle hardware modules to remote sources and for remote sources to be able to control existing OEM features.
